(19) United States
(12) Patent Application Publication
(10) Pub. No.: US 2010/0058936 A1
(43) Pub. Date: Mar. 11, 2010

(54) RECIRCULATING END COVER PLATES FOR A CONVEYOR OVEN

(76) Inventors: William S. Schjerven, SR., Schaumburg, IL (US); Theodore James Chmiola, Roscoe, IL (US)

Correspondence Address: MICHAEL BEST & FRIEDRICH LLP, Two Prudential Plaza, 180 North Stetson Avenue, Suite 2000, CHICAGO, IL, 60601, US

(21) Appl. No.: 12/549,984

(22) Filed: Aug. 28, 2009

Related U.S. Application Data
(60) Provisional application No. 61/094,423, filed on Sep. 5, 2008.

(51) Int. Cl. A21B 1/26; A21B 1/42; F27D 7/00; A21B 3/02

(52) U.S. Cl. 99/443 C; 126/21 A; 432/65

(57) ABSTRACT

A conveyor oven defines a heated cavity having an inlet opening and an outlet opening. A conveyor within the cavity extends between the openings. A cover plate is coupled to the oven to at least partially define one of the openings. The cover plate includes at least one air intake hole and at least one air return hole in fluid communication with one another through the first cover plate. Heated air in the cavity enters the cover plate through the at least one air intake hole adjacent the opening and exits the cover plate through the at least one air return hole at a location within the cavity that is spaced from the opening, thereby redirecting heated air that would otherwise escape the cavity from the opening back into the cavity.

### RELATED APPLICATIONS

This application claims priority to U.S. Provisional Patent Application No. 61/094,423 filed Sep. 5, 2008, the entire content of which is hereby incorporated by reference.

### BACKGROUND

Conveyor ovens are widely used for baking food items, especially pizzas, and the like. Examples of such ovens are shown, for example, in U.S. Pat. Nos. 5,277,105, 6,481,433, and 6,655,373, and International Patent Application No. PCT/US06/022304, each of which is hereby incorporated by reference.

Conveyor ovens typically comprise large metallic housings with a heated tunnel extending through them and a conveyor running through the tunnel. The conveyor (in the form, e.g., of a conveyor belt) transports food items through the heated oven tunnel at a speed calculated to properly bake food on the conveyor during the time the conveyor carries the food through the oven. The conveyor ovens include a heat delivery system and blowers which supply heat to the tunnel from a plenum through passageways leading to metal fingers opening into the oven tunnel at locations above and below the conveyor. The metal fingers act as airflow channels that deliver streams of hot air which impinge upon the surfaces of the food items passing through the tunnel on the conveyor.

### SUMMARY

Conveyor ovens include an entrance and an exit which allow the food item to pass into and exit from the heated tunnel. However, these openings also allow heated air to escape from the heated tunnel. Embodiments of the invention provide recirculating end cover plates that limit the amount of heated air that escapes from the heated tunnel and, thereby, increase the efficiency of the conveyor oven. It is also conceivable that the end cover plates could be used on other types of ovens that are not conveyor ovens, but that have at least one opening into the oven cavity.

The end cover plate includes one or more air intake holes on a portion adjacent to the opening and one or more air return holes on a portion adjacent to an air return. A blower draws air from the air return, thereby creating suction through the recirculating end cover plates. The suction causes heated air to be drawn through the recirculating end cover plate before the air is able to escape from the oven cavity.

In some embodiments of the invention, an air restriction plate is attached to the recirculating end cover plate to configure and optimize the amount of heated air that is drawn into the recirculating end cover plate and, subsequently, into the air return. In some embodiments, the air restriction plate is attachable on either edge of the recirculating end cover plate to limit the size, number, or location of the air intake holes or the air return holes.

More specifically, the invention provides a conveyor oven including an oven body defining therein a heated cavity having an inlet opening and an outlet opening, a conveyor within the heated cavity and extending from the inlet opening to the outlet opening, and a cover plate coupled to the oven body to at least partially define one of the inlet opening and the outlet opening. The cover plate includes at least one air intake hole and at least one air return hole in fluid communication with one another through the first cover plate. Heated air in the heated cavity enters the cover plate through the at least one air intake hole adjacent the one of the inlet opening and the outlet opening and exits the cover plate through the at least one air return hole at a location within the heated cavity that is spaced from the one of the inlet opening and the outlet opening, thereby redirecting heated air that would otherwise escape the heated cavity from the one of the inlet opening and the outlet opening back into the heated cavity.

The invention also provides a cover plate for an opening of an oven. The cover plate includes a first portion having therein at least one air intake hole and a second portion spaced from the first portion and having therein at least one air return hole in fluid communication with the at least one air intake hole through the cover plate. The cover plate is configured to be positioned at the opening of the oven such that the first portion is adjacent the opening and the second portion is spaced from the opening to redirect heated air adjacent the opening to a location spaced from the opening.

The invention further provides a method of minimizing the loss of heated air from an opening in a conveyor oven. The method includes positioning a cover plate over a portion of the opening, the cover plate having at least one air intake hole and at least one air return hole in fluid communication with the air intake hole, and creating a suction through the cover plate to draw heated air adjacent the opening into the at least one air intake hole, through the cover plate, and to the air return hole to redirect the heated air to a location in the conveyor oven spaced from the opening.

### BRIEF DESCRIPTION OF DRAWINGS

FIG. 1 is a perspective view of a conveyor oven according to an embodiment of the invention.

FIG. 2 is a perspective view showing internal components of the conveyor oven of FIG. 1, with arrows depicting the flow of air and with some components removed for clarity.

FIG. 3 is an enlarged partial perspective view of the recirculating end cover plates as installed on the conveyor oven of FIG. 1.

FIG. 4 is a perspective view of the recirculating end cover plates according to an embodiment of the invention.

FIG. 5 is another perspective view of the recirculating end cover plate according to an embodiment of the invention.

FIG. 5a is an exploded view of the recirculating end cover plate according to an embodiment of the invention.

FIG. 6 is a perspective view of the internal air circulation system of the oven of FIG. 1 including the recirculating end cover plates, with arrows depicting the flow of air and with some components removed for clarity.

### DETAILED DESCRIPTION

Before any embodiments of the invention are explained in detail, it is to be understood that the invention is not limited in its application to the details of construction and the arrangement of components set forth in the following descriptions or illustrated in the following drawings. The invention is capable of other embodiments and of being practiced or of being carried out in various ways.

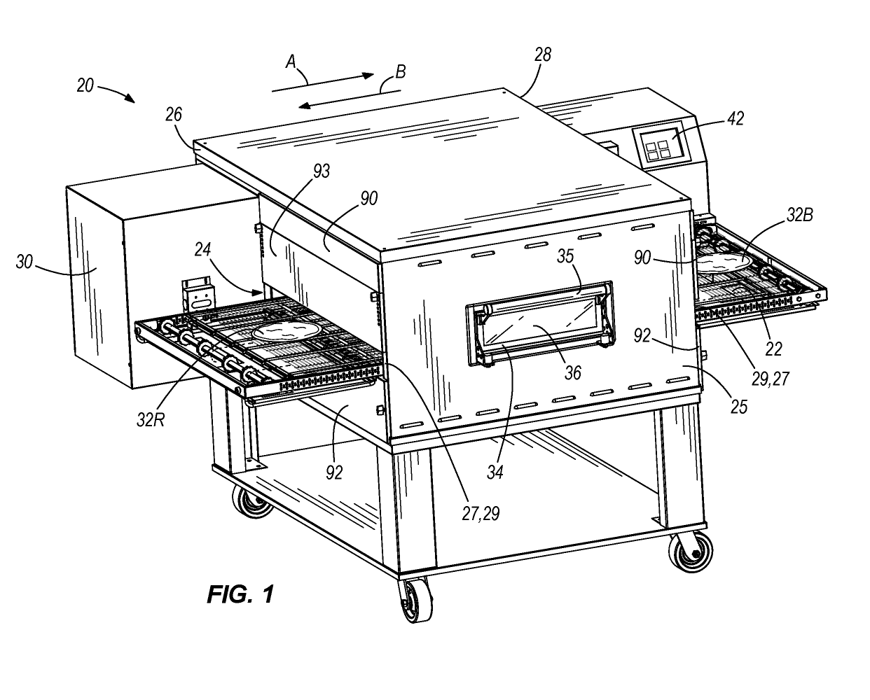

FIG. 1 shows a conveyor oven 20 having a conveyor 22 which runs through a heated tunnel or cavity 24 defined in a body 25 of the oven 20. The conveyor 22 has a width generally corresponding to the width of the heated tunnel 24 and is designed to travel in direction A from left oven end 26 toward right oven end 28 or, alternatively in direction B, from right oven end 28 toward left oven end 26. Thus, oven ends 26 and 28 may serve respectively as defining the inlet 27 and outlet 29 of the oven 20 with a rightwardly moving conveyor 22, or the outlet 27 and inlet 29 of the oven 20 with a leftwardly moving conveyor 22.

In the illustrated embodiment, a chain link drive is housed within compartment 30 at the left end 26 of the oven 20. Thus, a food product, such as a raw pizza 32R, may be placed on the conveyor 22 of the ingoing left oven end 26 and removed from the conveyor 22 as fully baked pizza 32B at the outgoing right oven end 28. The speed at which the conveyor 22 moves is coordinated with the temperature in the heated tunnel 24 so that the emerging fully cooked pizza 32B is properly baked.

A hinged door 34 is provided on the front of the oven 20, with a heat resistant glass panel 36 and a handle 35 so that a person operating the oven can view food product as it travels through the oven 20. A stainless steel metal frame surrounds the oven opening and provides a support for a gasket of suitable material (not shown), so that when the door 34 is in its closed position, it fits against and compresses the gasket to retain heat in the oven 20. Also, the operator may open the door 34 by pulling on handle 35 to place a different product on the conveyor 22 if less than a full bake cycle is required to produce a fully cooked product. The operation of the conveyor oven 20 can be controlled through controller 42.

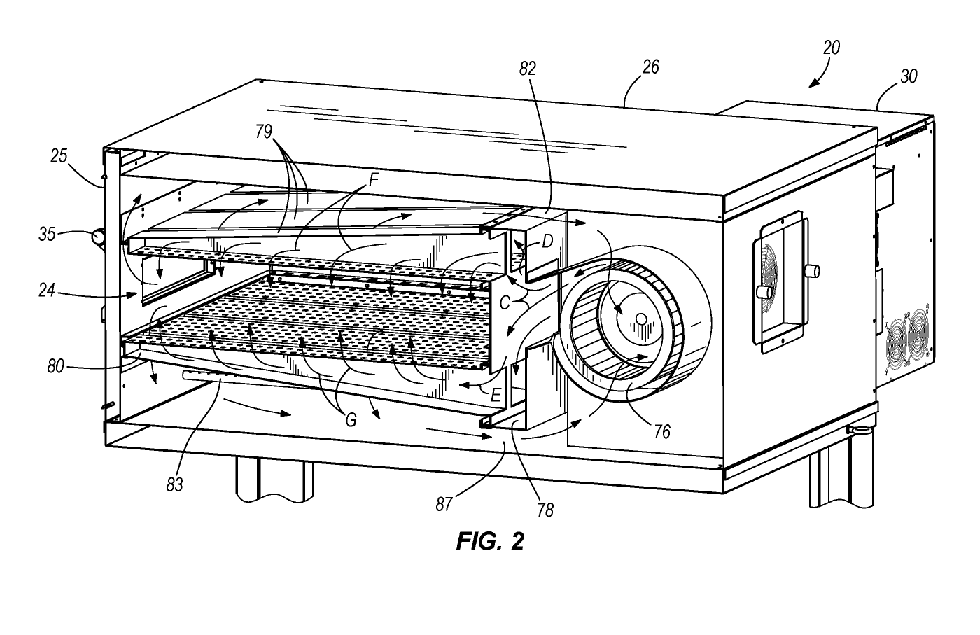

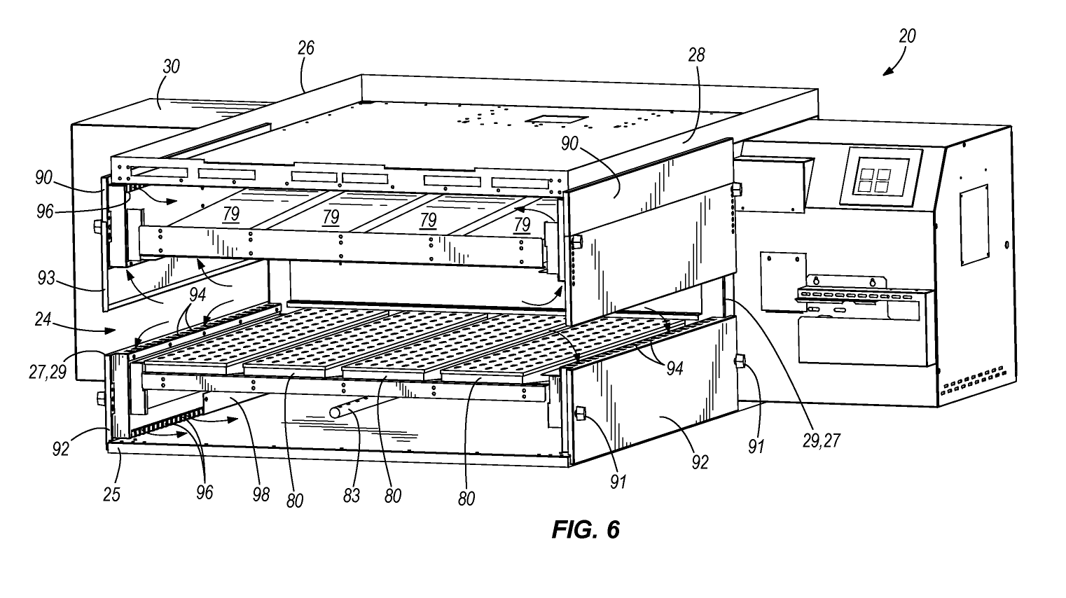

FIG. 2 illustrates some of the internal components of a conveyor oven according to one embodiment. Conveyor 22 (not shown in FIG. 2 or 6 for clarity) passes through oven cavity 24. One or more air blower fans 76 (shown as a blower scroll mechanism in this embodiment) draw air from the oven cavity 24 into the plenum 78. The metal impingement fingers 79, 80 are positioned above and below conveyor 22 in the oven cavity 24. The metal impingement fingers 79, 80 are constructed with one or more air channels that are connected to the plenum 78. The relatively high air pressure in the plenum 78 caused by the air blower fan 76 is forced through the air channels in the metal impingement fingers 79, 80. The metal impingement fingers 79, 80 direct the blown air toward the conveyor belt 22 (i.e., air exiting the plenum 78 through the upper fingers 79 is directed downward while air exiting the plenum 78 through the lower fingers 80 is directed upward). Air from the oven cavity 24 flows through the upper and lower air returns 82, 87 where it is again drawn by the air blower fans 76 and recirculated through the conveyor oven 20.

A burner tube 83 runs along the bottom of the oven cavity 24. The burner tube 83 provides fuel for a modulating gas valve (not pictured). The lighted gas valve heats the air in the oven cavity 24 and the food on the conveyor 22. In other embodiments, the oven 20 is heated by an electric resistance coil positioned inside the oven cavity 24 (e.g., beneath the conveyor belt 22). In still other embodiments, the gas or electric heating element is located in the plenum 78 and the food on conveyor 22 is cooked by blowing hot air onto the food. A temperature sensor (not shown) is positioned to measure the temperature of the air as it circulates through the air blower fans 76. The arrangement and number of fans and temperature sensors may vary as desired.

FIG. 2 illustrates the air flow in the conveyor oven 20. When the air blower fans 76 are operating, air located in the plenum 78 has the highest air pressure in the conveyor oven 20 because the air blower fans 76 are pushing more air directly into the plenum 78 (see arrow C). The lowest air pressure is in the rear cavity and the upper and lower air returns 82, 87, because the air blower fans 76 draw air directly from these areas.

Because high pressure air tends to flow toward areas of lower pressure, the air from the plenum 78 flows through the upper and lower impingement fingers 79, 80 (arrows D and E) and exits into the oven cavity 24 (arrows F and G). This arrangement blows the heated air onto the food items cooking on the conveyor 22. As the blowers 76 continue to provide air to the oven cavity 24 through the metal fingers 79, 80, the resulting pressure forces air from the oven cavity 24 into the upper and lower air returns 82, 87. The air then flows from the upper and lower air returns 82, 87 to the inlet of the blower scrolls 76. This mechanism recirculates the heated air from the oven cavity 24 over the food items being cooked.

Due to this flow of air, different areas within oven cavity 24 exhibit different air pressures. The area between the upper and lower metal impingement fingers 79, 80 has a relatively high air pressure compared to the areas above and below the metal fingers 79, 80. This is because air is being blown into the oven cavity 24 between the metal impingement fingers 79, 80 and drawn from the oven cavity 24 nearer to the upper and lower air returns 82, 87. Furthermore, the areas above the upper metal impingement finger 79 and below the lower metal impingement finger 80 have a higher air pressure on the side of the oven cavity 24 that is farther away from the upper and lower air returns 82, 87 (i.e., the left side of the image in FIG. 2).

As discussed above, some of the heated air will escape from the oven cavity through the entrance 27 and exit 29 openings of the heated tunnel 24 on either end of the conveyor oven 20. Several factors can contribute to the escaping heated air. For example, the increased air pressure caused by the blowers 76 can force the heated air to escape through the openings, particularly if the air pressure in the oven cavity 24 between the upper and lower metal fingers 79, 80 is greater than the atmospheric pressure outside of the conveyor oven 20. Also, convection and diffusion can cause the air on either side of an opening to attempt to reach thermal equilibrium (e.g., hot air escapes while cold air enters).

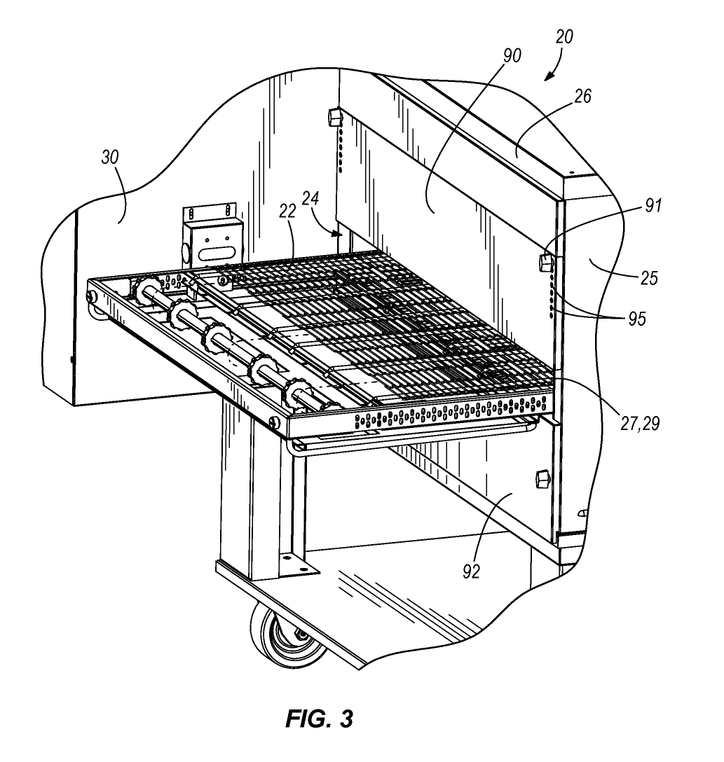

An end cover plate is a physical restriction at either end of a conveyor oven 20 that partially covers the side of the conveyor oven 20, leaving a specifically sized entrance (e.g., inlet 27) or exit (e.g., outlet 29) to the heated tunnel 24 for the conveyor 22 and food carried on the conveyor 22. An end cover or cover plate can be manufactured and installed in a variety of ways. For example, in some embodiments, the end cover plate is a single piece with an opening cut to define an entrance or exit for the conveyor 22 to the heated tunnel 24. In another embodiment, the end cover plate is a single piece positioned at either the top or bottom of the opening, above or below the conveyor 22. In other embodiments, the end cover plate includes two separate pieces that are installed above and below the conveyor 22. FIG. 3 shows an enlarged view of one opening to the conveyor oven 20. An upper end cover plate 90 and a lower end cover plate 92 are installed above and below the conveyor 22. An opening is created between the conveyor 22 and the upper end cover plate 90 to allow the conveyor to carry a food item into the heated tunnel 24. Upper and lower end cover plates 90, 92 are placed at both ends of the conveyor oven 20, thereby creating an entrance (e.g., inlet 27) and an exit (e.g., outlet 29) for the conveyor 22 to carry food through the heated tunnel 24. In some embodiments, the end cover plates 90, 92 are at least partially filled with an insulating material.

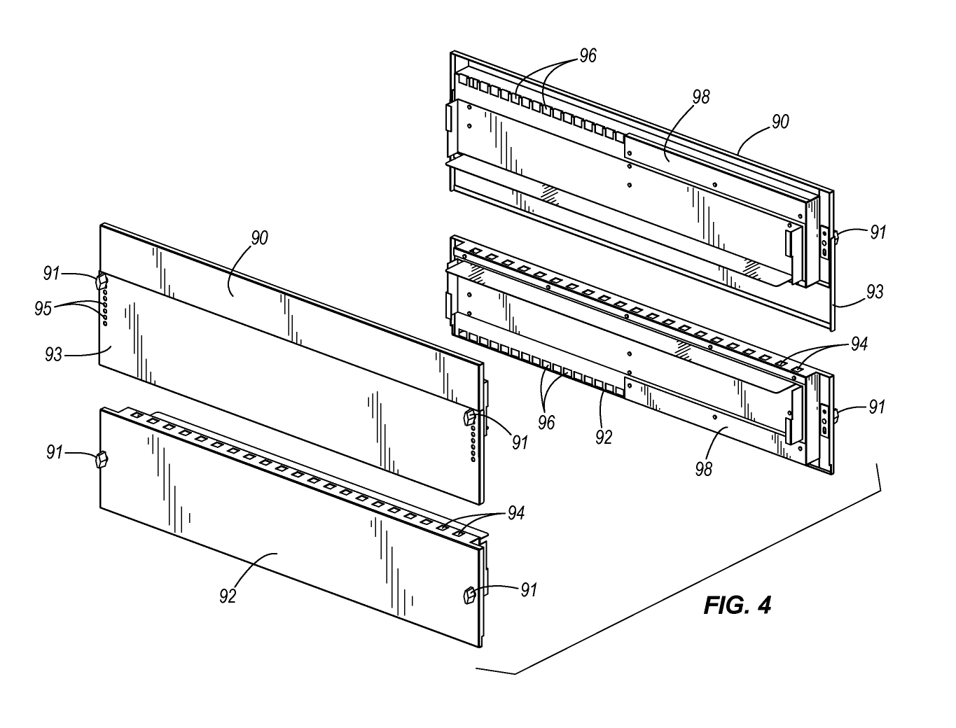

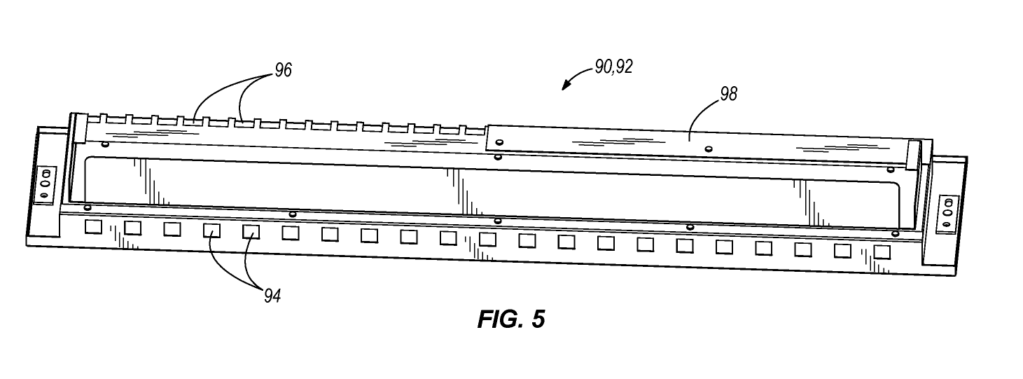

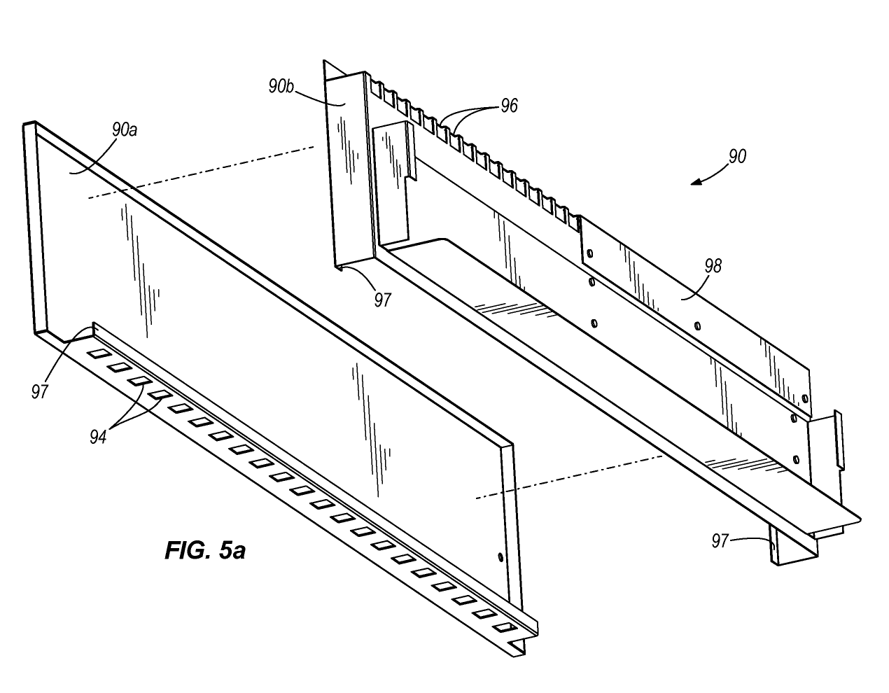

In addition to limiting the size of the openings of the heated tunnel 24, the end cover plates 90, 92 according to embodiments of the invention also minimize the amount of air escaping through the openings by providing a mechanism for recirculating air within the oven cavity 24. FIGS. 4, 5, and 5a illustrate the construction of the recirculating end cover plates 90, 92 according to one embodiment. Each of the four end cover plates (e.g., an upper and a lower end cover plate 90, 92 for each of the two ends of the conveyor oven 20) includes one or more air intake holes 94 positioned on one portion (e.g., an edge or adjacent an edge) of each end cover plate 90, 92 adjacent to the conveyor 22 (and therefore adjacent the inlet 27 or the outlet 29). One or more air return holes 96 in fluid communication with the respective air intake holes 94 through the end cover plates 90, 92 (e.g., via channels or other passageways) are positioned on another portion (e.g., an edge or adjacent an edge) of each end cover plate 90, 92 that is spaced from the portion containing the air intake holes 94. In some embodiments, insulating material is incorporated into the recirculating end cover plate 90 or 92 to reduce heat loss through thermal conduction.

FIG. 5a illustrates the construction of the cover plates 90, 92 (only cover plate 90 is shown), in which two separate sheet metal panels 90a, 90b are formed such that there is an interference fit or snap fit between them. This allows the two panels 90a, 90b to be snapped together and pulled apart, without conventional fasteners and without using tools, to facilitate cleaning of the interior of the cover plates 90, 92. More specifically, the panels 90a, 90b each include at least one flange 97 that secures the panels 90a, 90b together, and that can be resiliently flexed by hand to permit separation. While not shown in FIG. 5a, it is also possible to include insulating material between the panels 90a, 90b in some embodiments.

The cover plates 90, 92 can be secured to the oven body 25 in any suitable manner. In the illustrated embodiment, the cover plates 90, 92 are secured using fasteners 91 that can be conventional screws, bayonet-style, twist-to-lock fasteners, or other known fasteners. As illustrated in FIG. 4, the upper cover plate 90 includes an optional adjustment member or extension member in the form of a plate 93 that can be selectively coupled to and repositioned relative to the upper cover plate 90 to vary the overall height of the upper cover plate 90 (e.g., selectively increasing the overall height), thereby varying (e.g., selectively reducing) the size of the inlet 27 or outlet 29 defined in part by the upper cover plate 90. As illustrated, the fasteners 91 can extend through one of a plurality of spaced apertures 95 in the adjustment plate 93 to vary the position of the adjustment plate 93 relative to the upper cover plate 90. While the illustrated embodiment has the adjustment plate 93 shown only with the upper cover plate 90, it is to be understood that a similar adjustment plate can alternatively or additionally be provided on the lower cover plate 92. The upper and lower cover plates 90, 92 are substantially identical to one another with the exception of the addition of the optional adjustment plate 93.

FIG. 6 illustrates the flow of air through the end cover plates 90, 92. As described above, the air blower fans creates an area of relatively low air pressure in the area of the oven cavity 24 above and below the metal fingers 79, 80. The air return holes 96 of the recirculating end cover plates 90, 92 are located in this area of relatively low air pressure within the oven cavity 24 and at a location spaced from the inlet 27 and outlet 29. Because the area of the oven cavity 24 between the metal in fingers (adjacent to the conveyor 22) is closer to the output of the air blower fans 76, this area has a relatively high air pressure. The air intake holes 94 of the recirculating end cover plates 90, 92 are located in this area of relatively high pressure adjacent the inlet 27 and outlet 29. As such, air adjacent to the intake holes 94 is at a higher, first air pressure than the air adjacent to the return holes 96, which is at a lower, second pressure. This difference in pressure creates suction through the one or more air channels in the recirculating end cover plates 90, 92. The resulting effect is that air is drawn through the air intake holes 94 of each end cover plate 90 or 92 and flows through the air return holes 96 into the upper or lower air return 82, 89 where it is then drawn by one of the blower scrolls 76.

When the conveyor oven 20 is equipped with the end cover plates 90, 92, an area of concentrated suction is created in the oven cavity 24 near the entrance 27 and the exit 29 of the heated tunnel 24. Rather than allowing the heated air to escape the oven cavity 24 due to convection or diffusion, the active suction draws the heated air back into the upper and lower air returns 82, 89, thereby reducing the amount of heated air that is lost through the entrance 27 and exit 29 of the heated tunnel 24.

The force and nature of the suction caused by the recirculating end cover plates 90, 92 can be dependent upon the size, number and placement of the air intake holes 94 and air return holes 96. For example, as shown in FIGS. 4, 5, and 5a, although the air intake holes 94 are placed across the entire surface of the edge of the end cover plate 90 or 92 adjacent to the conveyor 22, the air return holes 96 are positioned only at the end of the opposite edge that is furthest away from the blowers 76. Such placement encourages the end cover plate 90 or 92 to draw air from the distant side of the oven cavity 24 so that the air circulation system (such as shown in FIGS. 2 and 6) can circulate heated air through all areas of the oven cavity 24. In some embodiments, such as shown in FIGS. 4, 5, and 5a, the number and location of air return holes 96 can be varied by installing an air restriction plate 98 over one or more of the air return holes 96, thereby covering one or more of the air return holes 96. A similar arrangement can be implemented to adjust the number and location of the air intake holes 94.

The amount of energy (electricity or gas) required to maintain an internal oven temperature is affected by the amount of heated air that escapes through the entrance 27 and exit 29 of the heated tunnel 24. For example, when hot air escapes relatively cold air enters. The heating element (e.g., an electric coil or a gas burner) must produce a greater thermal output in order to heat the relatively cold air and to maintain a constant temperature. The recirculating end cover plates 90, 92 reduce the amount of hot air that escapes from the oven cavity 24 and, thereby, reduce the amount of energy required to maintain the internal oven temperature.

It should be understood that the invention has been described above by reference to exemplary embodiments. Other configurations and designs are possible. Various features and advantages of the invention are set forth in the following claims.

1. A conveyor oven comprising:
an oven body defining therein a heated cavity having an inlet opening and an outlet opening;
a conveyor within the heated cavity and extending from the inlet opening to the outlet opening; and
a cover plate coupled to the oven body to at least partially define one of the inlet opening and the outlet opening, the cover plate including at least one air intake hole and at least one air return hole in fluid communication with one another through the first cover plate;
wherein heated air in the heated cavity enters the cover plate through the at least one air intake hole adjacent the one of the inlet opening and the outlet opening and exits the cover plate through the at least one air return hole at a location within the heated cavity that is spaced from the one of the inlet opening and the outlet opening, thereby redirecting heated air that would otherwise escape the heated cavity from the one of the inlet opening and the outlet opening back into the heated cavity.

2. The conveyor oven of claim 1, further including an adjustment member coupled to the cover plate to increase an overall height of the cover plate, thereby reducing a size of the one of the inlet opening and the outlet opening.

3. The conveyor oven of claim 2, wherein the adjustment member can be coupled to the cover plate in one of a plurality of positions to vary the overall height of the cover plate.

4. The conveyor oven of claim 1, wherein the cover plate includes a plurality of air return holes, and further including an air restriction plate covering at least one of the plurality of air return holes.

5. The conveyor oven of claim 1, wherein the cover plate is a first cover plate and wherein the conveyor oven includes a second cover plate coupled to the oven body and at least partially defining the one of the inlet opening and the outlet opening with the first cover plate such that the first cover plate defines an upper cover plate above the conveyor and the second cover plate defines a lower cover plate below the conveyor.

6. The conveyor oven of claim 5, wherein the second cover plate includes at least one air intake hole and at least one air return hole in fluid communication with one another through the second cover plate, wherein heated air in the heated cavity enters the second cover plate through the at least one air intake hole adjacent the one of the inlet opening and the outlet opening and exits the second cover plate through the at least one air return hole at a location within the heated cavity that is spaced from the one of the inlet opening and the outlet opening, thereby redirecting heated air that would otherwise escape the heated cavity from the one of the inlet opening and the outlet opening back into the heated cavity.

7. The conveyor oven of claim 5, wherein the first and second cover plates together at least partially define the inlet opening, and wherein the conveyor oven further includes third and fourth cover plates coupled to the oven body to at least partially define the outlet opening.

8. The conveyor oven of claim 7, wherein at least one of the third and fourth cover plates includes at least one air intake hole and at least one air return hole in fluid communication with one another through the respective cover plate, wherein heated air in the heated cavity enters the at least one of the third and fourth cover plates through the at least one air intake hole adjacent the outlet opening and exits the at least one of the third and fourth cover plates through the at least one air return hole at a location within the heated cavity that is spaced from the outlet opening, thereby redirecting heated air that would otherwise escape the heated cavity from the outlet opening back into the heated cavity.

9. The conveyor oven of claim 8, wherein each of the third and the fourth cover plates includes at least one air intake hole and at least one air return hole in fluid communication with one another through the respective cover plate.

10. The conveyor oven of claim 1, wherein the cover plate is a first cover plate at least partially defining the inlet opening, and wherein the conveyor oven includes a second cover plate coupled to the oven body and at least partially defining the outlet opening, the second cover plate including at least one air intake hole and at least one air return hole in fluid communication with one another through the second cover plate such that heated air in the heated cavity enters the second cover plate through the at least one air intake hole adjacent the outlet opening and exits the second cover plate through the at least one air return hole at a location within the heated cavity that is spaced from the outlet opening, thereby redirecting heated air that would otherwise escape the heated cavity from the outlet opening back into the heated cavity.

11. The conveyor oven of claim 1, wherein the cover plate is formed from two sheet metal panels having an interference fit.

12. A cover plate for an opening of an oven, the cover plate comprising:
a first portion having therein at least one air intake hole; and
a second portion spaced from the first portion and having therein at least one air return hole in fluid communication with the at least one air intake hole through the cover plate;
wherein the cover plate is configured to be positioned at the opening of the oven such that the first portion is adjacent the opening and the second portion is spaced from the opening to redirect heated air adjacent the opening to a location spaced from the opening.

13. The cover plate of claim 12, further including an adjustment member coupled to the cover plate to increase an overall height of the cover plate, thereby reducing a size of the opening.

14. The cover plate of claim 13, wherein the adjustment member can be coupled to the cover plate in one of a plurality of positions to vary the overall height of the cover plate.

15. The cover plate of claim 12, wherein the at least one air return hole includes a plurality of air return holes, and further including an air restriction plate covering at least one of the plurality of air return holes.

16. The cover plate of claim 12, wherein the cover plate is formed from two sheet metal panels having an interference fit.

17. A method of minimizing the loss of heated air from an opening in a conveyor oven, the method comprising:
positioning a cover plate over a portion of the opening, the cover plate having at least one air intake hole and at least one air return hole in fluid communication with the air intake hole; and
creating a suction through the cover plate to draw heated air adjacent the opening into the at least one air intake hole, through the cover plate, and to the air return hole to redirect the heated air to a location in the conveyor oven spaced from the opening.

18. The method of claim 17, wherein creating a suction through the cover plate includes positioning the at least one air intake hole adjacent an area having a first pressure within the conveyor oven and positioning the at least one air return hole adjacent an area having a second pressure, lower than the first pressure, within the conveyor oven.

19. The method of claim 17, wherein the cover plate includes a plurality of air return holes, and wherein creating a suction through the cover plates includes positioning an air restriction plate over at least one of the plurality of air return holes.

20. The method of claim 17, wherein the cover plate is a first cover plate, the method further comprising:
positioning a second cover plate over a portion of the opening, the second cover plate having at least one air intake hole and at least one air return hole in fluid communication with the air intake hole; and
creating a suction through the second cover plate to draw heated air adjacent the opening into the at least one air intake hole, through the second cover plate, and to the air return hole to redirect the heated air to a location in the conveyor oven spaced from the opening.

21. The method of claim 17, wherein the cover plate is a first cover plate and wherein the opening is an inlet opening, the method further comprising
positioning a second cover plate over an outlet opening, the second cover plate having at least one air intake hole and at least one air return hole in fluid communication with the air intake hole; and
creating a suction through the second cover plate to draw heated air adjacent the outlet opening into the at least one air intake hole, through the second cover plate, and to the air return hole to redirect the heated air to a location in the conveyor oven spaced from the outlet opening.

22. The method of claim 17, further comprising coupling an adjustment member to the cover plate to selectively vary a size of the opening.
